(19) United States
(12) Patent Application Publication
(10) Pub. No.: US 2007/0036886 A1
(43) Pub. Date: Feb. 15, 2007

(54) Vegetable and fruit peeler

(76) Inventors: Russell Romeo Primavera, Arvada, CO (US); Laurie Ann Primavera, Arvada, CO (US); Bryce Andrew Primavera, Arvada, CO (US)

Correspondence Address: Benjamin Aaron Adler, Ph.D., J.D., 8011 Candle Ln, Houston, TX, 77071, US

(21) Appl. No.: 11/452,863

(22) Filed: Jun. 14, 2006

Related U.S. Application Data
(60) Provisional application No. 60/702,059, filed on Jul. 22, 2005.

(51) Int. Cl. A23P 1/00

(52) U.S. Cl. 426/482; 426/478; 426/479; 426/481; 99/537; 99/567; 99/584; 99/587

(57) ABSTRACT

The invention discloses a system to remove the skin, veins and seeds of a fruit or vegetable. The system comprises an inclined board with ridges to hold the fruit or vegetable to be treated and a hand tool with an edge adapted to remove the skin, veins and seeds of a fruit or vegetable that is placed on the ridged board. The invention further discloses methods to remove the skin, seeds and veins from a fruit or vegetable using the board and hand tool.

### CROSS-REFERENCE TO RELATED APPLICATION

This non-provisional application claims benefit of provisional U.S. Ser. No. 60/702,059, filed Jul. 22, 2005, now abandoned.

### BACKGROUND OF THE INVENTION

1. Field of the Invention

The present invention relates generally to kitchen utensils such as vegetables and fruits peelers. More specifically, the present invention relates to a system for removal of seeds, veins and skin of vegetables and fruits.

2. Description of the Related Art

There are a number of kitchen tools that are available for peeling the skin of vegetables and fruits. For example, U.S. Pat. No. 4,430,931 describes a peeler for skinning cylindrical vegetables. The peeler has at least first and second pairs of parallel knife members that can be spaced as per the diameter of the vegetable to be processed. U.S. Pat. No. 5,168,802 discloses a peeler for peeling fruits and vegetables comprising a plurality of rotatably driven peeling elements having predetermined axes of rotation that are generally horizontal and substantially parallel to one another. The peeling elements have a provision for engaging the peel of the fruits and vegetables. U.S. Pat. No. 5,669,293 provides an apparatus for peeling asparagus. The device has a housing with a passage designed to permit a stick of asparagus to be inserted. Inside the housing are several peeling blades, which are disposed in different directions of the passage.

U.S. Pat. No. 6,478,292 describes an elevated non-slip cutting board. This cutting board has a rigid planar baseboard to which is fixed a traction means having at least 13 downwardly directed spaced apart projections to provide support and the free flow of fluid underneath the cutting board and which provides enhanced traction to retard slippage of the cutting board during the cutting or support process. In addition, U.S. Pat. No. 7,040,611 describes a cutting board comprising a slab of polyethylene made as a unitary molding. The board includes a central cutting zone, which drains to a liquid sump in one corner of the board.

The above cited U.S. patents and the general design of existing peelers and cutting boards is to treat vegetables and fruits that are generally rigid such as carrots, potatoes, asparagus, apples etc. These devices do not address the processing of fruits or vegetables that are soft as a result of boiling or roasting such as for example roasted peppers. A boiled or roasted vegetable or fruit may disintegrate to an undesirable form if it is placed between the sharp knives or blades of conventional peelers.

Fresh roasted pepper is a delicacy savored by many. However the cleaning of such roasted peppers prior to their consumption is a difficult task. On roasting, the pepper becomes soft and conventional handling such as placing the peppers in a bucket of water or under the faucet to remove their seeds, veins and skin can often lead to the pepper losing most of its flavorful juices. Such handling of roasted peppers can also cause the pepper to disintegrate into a pulp, which is undesirable.

Thus there is a need in the art for a device to skin, remove veins and deseed roasted vegetables and fruits such as roasted pepper. More specifically there is a need for a device that can perform all these functions without causing undesirable damage to the fruit or vegetable. The present invention fulfils this long-standing need in the art.

### SUMMARY OF THE INVENTION

The present invention is directed to a system for peeling fruits and vegetables, comprising an inclined board having an upper surface with a plurality of parallel ridges laterally disposed thereon adapted to hold a fruit or vegetable thereon. The board has a downwardly extending support member adapted to support the board in an inclined position when the board is placed on a surface. The system further comprises a hand tool having an upper end adapted for being held by hand and a lower end downwardly inclined from the upper end and with a lower edge adapted to peel a fruit or vegetable placed on the inclined board.

In another embodiment is provided a method to peel a vegetable or fruit using the above tool. The method comprises: (a) placing the fruit or vegetable on the inclined board; (b) pressing the fruit or vegetable against the ridges of the board with one hand; and (c) placing the lower edge of the lower end of the hand tool on one end of the fruit or vegetable with the other hand and pulling the hand tool along the length of said fruit or vegetable to peel the fruit or vegetable.

In yet another embodiment is provided a system for peeling a vegetable or fruit comprising an inclined and outwardly curved rectangular board having an upper surface comprising a plurality of parallel upwardly inclined rectangular ridges laterally disposed thereon adapted to hold a fruit or vegetable and an inclined downwardly extending rectangular support member adapted to support the board in an inclined position when the board is placed on a surface. The system further comprises a hand tool having a rectangular upper end adapted for being held by hand and a rectangular lower end downwardly inclined from the upper end and with a lower edge adapted to peel a fruit or vegetable placed on the board.

In still another embodiment is provided a method to remove the seeds, veins and skin of roasted pepper using the system described above, comprising: (a) cutting open the pepper longitudinally to expose the seeds and veins; (b) placing the pepper on the board such that the veins and seeds are external to the board and pressing the pepper down on the board with one hand to hold the pepper against the ridges on the board; (c) placing the lower edge of the lower end of the hand tool on one end of the pepper with the other hand and pulling the hand tool along the length of the pepper to remove the seeds and veins; and (d) turning the pepper over on said board and repeating step (c) to remove the skin from the pepper.

Other and further aspects, features, and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention, as well as others, which will become clear, are attained and can be understood in detail, more particular descriptions of the invention are briefly summarized. The above may be better understood by reference to certain embodiments thereof, which are illustrated in the appended drawings. These drawings form a part of the specification. It is to be noted; however, that the appended drawings illustrate preferred embodiments of the invention and therefore are not to be considered limiting in their scope.

FIGS. 1A-1B show a system for peeling a vegetable or fruit. FIG. 1A shows an inclined and ridged board for holding the fruit or vegetable FIG. 1B shows a hand tool for removing the seeds, veins and skin from a fruit or vegetable that is placed and held against the ridges of the inclined board.

FIG. 2 illustrates the peeling of roasted pepper skin using the system described in FIGS. 1A-1B.

### DETAILED DESCRIPTION OF THE INVENTION

A cooked vegetable or fruit becomes soft and removal of skin, seeds and veins usually results in loss of flavorful juices and disintegration of the fruit or vegetable to a pulp. The instant invention is directed to a system that specifically overcomes such problems associated with processing whole cooked vegetables and fruits. The system can also be used to peel other food material such as fish, poultry and meat and raw fruits and vegetables.

In one embodiment, the present invention provides a system for peeling fruits and vegetables, comprising an inclined board having an upper surface with a plurality of parallel ridges laterally disposed thereon adapted to hold a fruit or vegetable thereon. The board has a downwardly extending support member adapted to support the board in an inclined position when the board is placed on a surface. The system further comprises a hand tool having an upper end adapted for being held by hand and a lower end downwardly inclined from the upper end and with a lower edge adapted to peel a fruit or vegetable placed on the inclined board. Preferably the angle of inclination between the upper and lower ends of the hand tool is between about 145° to about 160°. In all aspects of this embodiment the board can have a perforation on the upper edge of the board such that this perforation acts as a suspension point for a hook. The board can be hung on the kitchen wall for example via the perforation using a hook.

In all aspects of this embodiment the fruit or vegetable that can be treated can be raw or cooked. Generally any fruit or vegetable that is cooked by roasting can be processed using the instant device. Roasted eggplants and peppers are examples of vegetables that can be processed using this system. Specifically the system can be used to remove the skin, seeds and veins of roasted pepper such as for example roasted Bell or Banana peppers. The system may also be used to remove scales from fish or to peel poultry or meat.

In all aspects of this embodiment the board and hand tool may comprise flexible materials. The board and hand tool can be of any material that is generally regarded as safe for use with food material. Preferably, the material is polypropylene. The flexibility of the board and hand tool and the inclination of both these components ensure that excessive pressure is not imposed on the fruit or vegetable being processed when the hand tool is pulled down the fruit or vegetable. Excessive pressure on any food material can cause the food material to disintegrate into an undesirable form and shape.

In all aspects of this embodiment the board can curve in the outward direction. This design reinforces the flexibility of the board. Preferably the support member which is attached to the board and the upper edge of the board include an angle that is either ≦90°. More preferably this angle is not lesser than 80°. This angle enhances both the ability of the board to grip the fruit or vegetable as well as the stripping mechanism. The support member can be rectangular in shape. If the support member is rectangular in shape then the length of the support member can be about 15 cm to about 20 cm and the width or height of the support member can be about 2 cm to about 4 cm.

Furthermore in all aspects of this embodiment the board and hand tool can have any geometric shape. Preferably both the board and the hand tool are rectangular in shape. More preferably if the board is rectangular in shape then the length of the board is about 20 cm to about 30 cm and the width of the board is about 12 cm to about 20 cm. If the holding tool is rectangular in shape then preferably the holding end is about 8 cm to about 12 cm in length and about 3 cm to about 6 cm in width and the lower end is about 8 cm to about 12 cm in length and about 1 cm to about 2 cm in width.

In all aspects of this embodiment the ridges on the upper surface of the board can be of any geometry that can serve to hold the food material to be treated on the board. Preferably the ridges are rectangular in shape and are upwardly inclined from the surface of the board (A specific advantage of this design, i.e., the ridges being upwardly inclined enhances the ability of one to strip the skin off the vegetable or the fruit. If the ridges are rectangular then preferably the length of each ridge is about 15 cm to about 20 cm, the width of each ridge is about 2 cm to about 3 cm and the distance between the upper edge of each ridge to the surface of the board is about 1 mm to about 2 mm.

In another embodiment the present invention provides a method for peeling vegetables and fruits using the system as described supra. The method comprises: (a) placing the fruit or vegetable on the inclined board; (b) pressing the fruit or vegetable against the ridges of the board with one hand; and (c) placing the lower edge of the lower end of the hand tool on one end of the fruit or vegetable with the other hand and pulling the hand tool along the length of said fruit or vegetable to peel said fruit or vegetable. In all aspects of this embodiment the food material, the geometry and dimensions of the board and the hand tool are as described supra.

In yet another embodiment the present invention provides a system to peel a vegetable or fruit comprising an inclined outwardly curving rectangular board having an upper surface comprising a plurality of parallel upwardly inclined rectangular ridges laterally disposed thereon adapted to hold a fruit or vegetable and an inclined downwardly extending rectangular support member adapted to support the board in an inclined position when the board is placed on a surface. The system further comprises a hand tool having a rectangular upper end adapted for being held by hand and a rectangular lower end downwardly inclined from the upper end and with a lower edge adapted to peel a fruit or vegetable placed on the board. In all aspects of this embodiment the board can have a perforation on the upper edge of the board such that this perforation acts as a suspension point for a hook. The board can be hung on the kitchen wall for example via the perforation using a hook.

In all aspects of this embodiment the food material that can be treated using this system is as described supra. Preferably the board and hand tool comprise flexible material. More preferably the length of the board is about 20 cm to about 30 cm and the width of the board is about 12 cm to about 20 cm and the upper end of the hand tool is about 8 cm to about 12 cm in length and about 3 cm to about 6 cm in width and the lower end of the hand tool is about 8 cm to about 12 cm in length and about 1 cm to about 2 cm in width. Preferably the support member which is attached to the board and the upper edge of the board include an angle that is either ≦90°. More preferably this angle is not lesser than 80°. Preferably the support member can be about 15 cm to about 20 cm in length and the width or height of the support member can be about 2 cm to about 4 cm.

In still another embodiment is provided a method for peeling vegetables and fruits using the system as described supra. The method comprises: (a) placing the fruit or vegetable on the inclined board; (b) pressing the fruit or vegetable against the ridges of the board with one hand; and (c) placing the lower edge of the lower end of the hand tool on one end of the fruit or vegetable with the other hand and pulling the hand tool along the length of said fruit or vegetable to peel said fruit or vegetable. In all aspects of this embodiment the food material, the geometry and dimensions of the board and the hand tool are as described supra.

In a related embodiment is provided a method to remove the seeds, veins and skin of roasted pepper using the system as described supra comprising: (a) cutting open the pepper longitudinally to expose the seeds and veins; (b) placing the pepper on the board such that the veins and seeds are external to the board and pressing the pepper down on the board with one hand to hold the pepper against the ridges on the board; (c) placing the lower edge of the lower end of the hand tool on one end of the pepper with the other hand and pulling the hand tool along the length of the pepper to remove the seeds and veins; and (d) turning the pepper over on said board and repeating step (c) to remove the skin from the pepper.

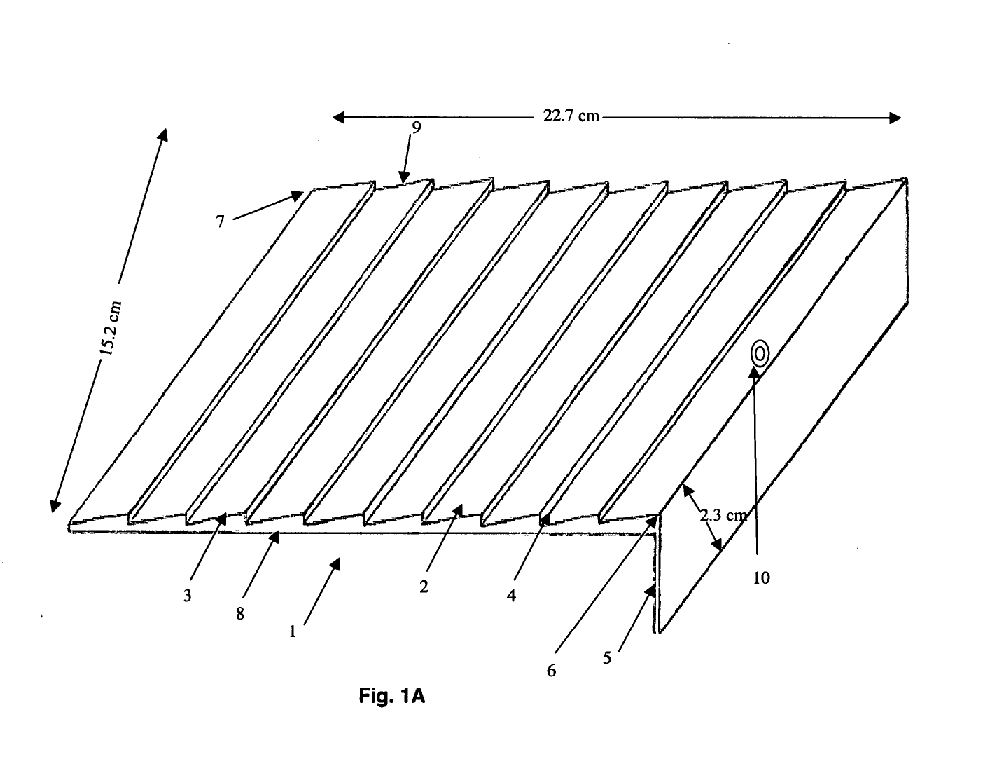

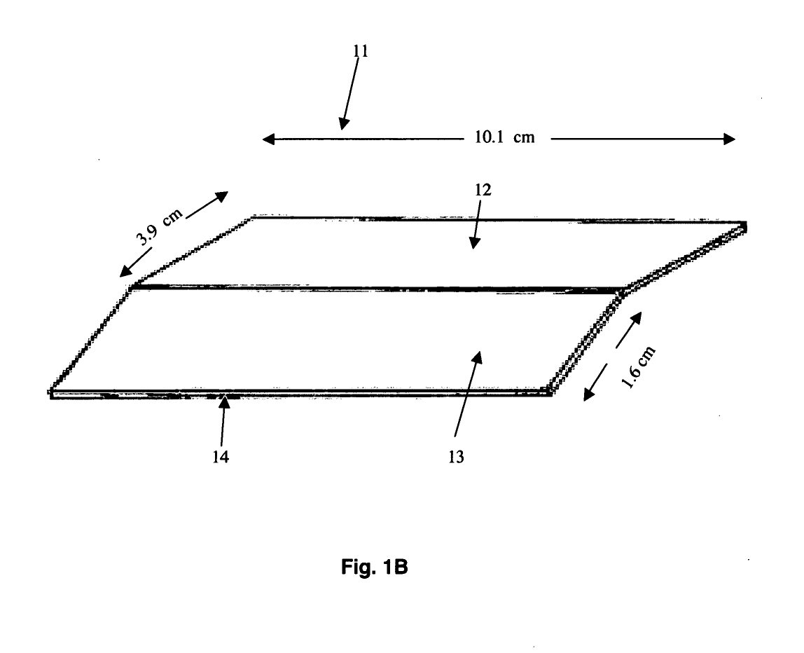

Referring now to FIG. 1A, the flexible rectangular board 1 has a series of parallel upwardly inclined laterally disposed rectangular ridges 2 on the upper surface 3. The upper edge 4 of each ridge 2 is approximately 2 mm from the surface of the inclined board 1. A support member 5 extends downwardly from the upper edge 6 to hold the board 1 in an inclined position when the board is placed on a surface (not shown). The lower edge 7 of the board 1 rests on the surface when the board 1 is placed on a surface. The two side edges 8 and 9 of the board 1 are elevated above the surface when the board is placed on a surface. The board 1 has a perforation 10 to hang the board on a wall (not shown).

Referring now to FIG. 1B, the hand tool 11 has a rectangular upper end 12 for holding and a downwardly inclined lower end 13 extending from the upper end 12. The lower end 13 has a lower edge 14 adapted to peel food material (not shown) held on board 1 of FIG. 1A.

As used herein ‘upper edge of the board’ refers to the edge of the board to which the support member is attached and which is elevated above the surface when the board is placed on a surface. The edge opposite the upper edge of the board is defined as ‘lower edge’ and this edge rests on the surface when the board is placed on a surface. As used herein ‘upper end’ of the hand tool refers to the end that is used to hold the tool and the ‘lower end’ of the hand tool is the end that is downwardly inclined from the upper end of the hand tool. The ‘lower edge’ of the lower end of the hand tool is the edge of the lower end of the hand tool that is parallel to the junction between the upper and lower end of the hand tool.

Provided herein is a versatile system that can be used to perform three different functions of removing the skin, the seeds and the veins from a fruit or vegetable. The system also provides a solution for processing cooked whole vegetables and fruits that are soft and cannot be handled using conventional peelers that use sharp knives. Furthermore the board comprising the system may be used to hold any food material that is to be processed for example to be chopped or carved. The ridged upper surface of the board allows for a good grip on the food material to be treated. Likewise the hand tool may be used with other chopping or cutting boards to peel food material such as fruits, vegetables, fish, poultry and meat.

The board and hand tool described herein can be made of any material that is regarded as safe for treating food material and commonly employed in making cutting boards for processing food material. The ridges on the board can either be etched using techniques known in the art or the ridged board can be prepared by using a mold. The upper edge of the ridge that extends from the board can be made to be moderately sharp. ‘Moderately sharp’ as used herein means sharp enough to grip or hold food material but not sharp enough to cut through the food material that is to be held on the board. Similarly the lower edge of the lower end of the hand tool is adapted to peel skin off vegetables and fruits. So the lower edge of the hand tool can either be moderately sharp or sharp such as a knife to peel any food material.

The following example is given for the purpose of illustrating an embodiment of the invention and is not meant to limit the present invention in any fashion.

### EXAMPLE 1

Preparation of Fresh Roasted Pepper Using the System Described Instant Vegetable and Fruit Peeler

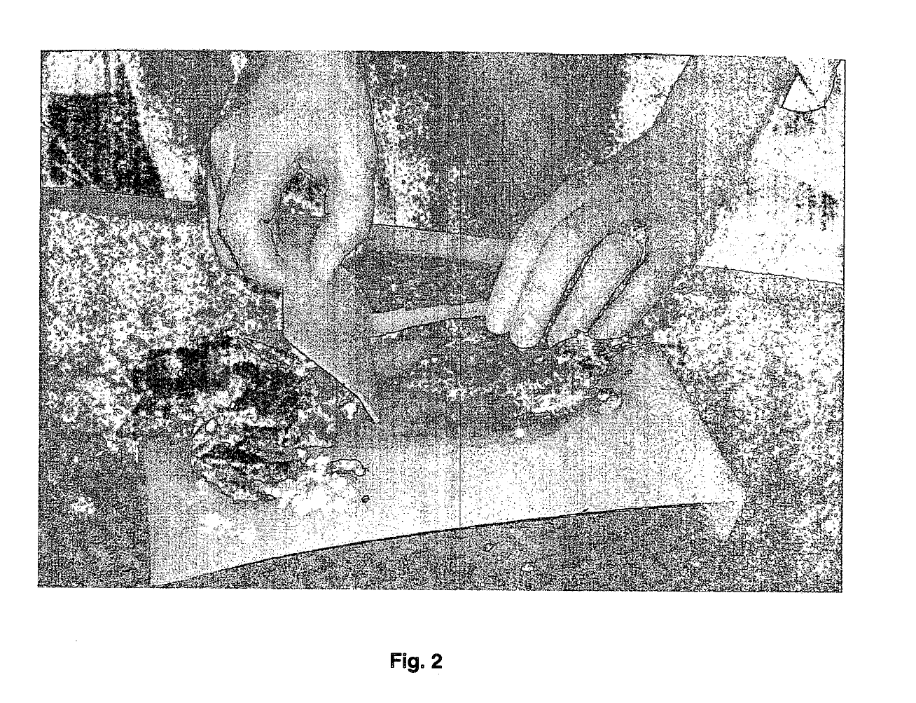

A freshly roasted pepper is first allowed to sweat in a container for about 15-20 minutes. The pepper is then opened to expose the seeds and veins and then pressed on the inclined board. The hand tool is placed on the pepper with the lower edge of the lower end touching the pepper surface and pulled down along the length of the pepper to remove the seeds and veins. The pepper is then turned over on the board and the process is repeated to peel the pepper skin (FIG. 2).

Any patents mentioned in this specification are indicative of the levels of those skilled in the art to which the invention pertains. Further, these patents are incorporated by reference herein to the same extent as if each individual patent was specifically and individually incorporated by reference.

One skilled in the art will readily appreciate that the present invention is well adapted to carry out the objects and obtain the ends and advantages mentioned, as well as those inherent therein. Changes therein and other uses will occur to those skilled in the art which are encompassed within the spirit of the invention as defined by the scope of the claims.

What is claimed is:

1. A system for peeling fruits and vegetables, comprising:
(a) an inclined board having an upper surface comprising a plurality of parallel ridges laterally disposed thereon adapted to hold a fruit or vegetable thereon and a downwardly extending support member adapted to support said board in an inclined position when said board is placed on a surface; and
(b) a hand tool having an upper end adapted for being held by hand and a lower end downwardly inclined from the upper end and with a lower edge adapted to peel a fruit or vegetable placed on said board.

2. The system of claim 1, wherein said board and said hand tool comprise a flexible material.

3. The system of claim 1, wherein said board curves in the convex direction.

4. The system of claim 1, wherein said support member extends downwardly from the upper edge of said board such that the angle included between the edge of the support member which is attached to said board and the upper edge of said board is about ≦90°.

5. The system of claim 1, wherein said board is rectangular in shape.

6. The system of claim 5, wherein the length of the board is about 20 cm to about 30 cm, the width of the board is about 12 cm to about 20 cm and the height of said support member is about 2 cm to about 4 cm.

7. The system of claim 5, wherein said ridges are rectangular in shape and are upwardly inclined from the surface of said board.

8. The system of claim 7, wherein the length of each ridge is about 15 cm to about 20 cm, the width of each ridge is about 2 cm to about 3 cm and the distance between the upper edge of each ridge to the surface of said board is about 1 mm to about 2 mm.

9. The system of claim 5, wherein said support member is rectangular in shape.

10. The system of claim 9, wherein said support member is about 15 cm to about 20 cm in length and about 2 cm to about 4 cm in width.

11. The system of claim 1, wherein the angle of inclination between said upper and lower ends of said hand tool is between 145-160°.

12. The system of claim 1, wherein said holding end of said hand tool is rectangular in shape.

13. The system of claim 12, wherein said holding end is about 8 cm to about 12 cm in length and about 3 cm to about 6 cm in width.

14. The system of claim 1, wherein said lower end of said holding tool is rectangular in shape.

15. The system of claim 14, wherein said lower end is about 8 cm to about 12 cm in length and about 1 cm to about 2 cm in width.

16. The system of claim 1, wherein said board has a perforation on the upper edge said perforation adapted to act as a suspension point for a hook.

17. A method for peeling vegetables and fruits using the system of claim 1, comprising:
(a) placing said fruit or vegetable on said board;
(b) pressing said fruit or vegetable against the ridges of said board with one hand; and
(c) placing the lower edge of the lower end of said hand tool on one end of the fruit or vegetable with the other hand and pulling the hand tool along the length of said fruit or vegetable to peel said fruit or vegetable.

18. A system for peeling vegetables and fruits comprising:
(a) an inclined outwardly curving rectangular board having an upper surface comprising a plurality of parallel upwardly inclined rectangular ridges laterally disposed thereon adapted to hold a fruit or vegetable and a rectangular inclined downwardly extending rectangular support member adapted to support said board in an inclined position when said board is placed on a surface; and
(b) a hand tool having a rectangular upper end adapted for being held by hand and a rectangular lower end downwardly inclined from the upper end and with a lower edge adapted to peel a fruit or vegetable placed on said board.

19. The system of claim 18, wherein said board and said hand tool comprise a flexible material.

20. The system of claim 18, wherein said support member extends downwardly from the upper edge of said board such that the angle included between the edge of the support member which is attached to said board and the upper edge of said board is either ≦90°.

21. The system of claim 18, wherein the length of the board is about 20 cm to about 30 cm, the width of the board is about 12 cm to about 20 cm and the height of said support member is about 2 cm to about 4 cm.

22. The system of claim 18, wherein the length of each ridge is about 15 cm to about 20 cm, the width of each ridge is about 2 cm to about 3 cm and the distance between the upper edge of each ridge to the surface of said board is about 1 mm to about 2 mm.

23. The system of claim 18, wherein said support member is about 15 cm to about 20 cm in length and about 2 cm to about 4 cm in width.

24. The system of claim 18, wherein the angle of inclination between said upper and lower ends of said hand tool is between 145-160°.

25. The system of claim 18, wherein said holding end of said hand tool is about 8 cm to about 12 cm in length and about 3 cm to about 6 cm in width.

26. The system of claim 18, wherein said lower end of said hand tool is about 8 cm to about 12 cm in length and about 1 cm to about 2 cm in width.

27. The system of claim 18, wherein said board has a perforation on the upper edge said perforation adapted to act as a suspension point for a hook.

28. A method for peeling a vegetable or fruit using the system of claim 18, comprising:
(a) placing said fruit or vegetable on said board;
(b) pressing said fruit or vegetable against the ridges of said board with one hand; and
(c) placing the lower edge of the lower end of said hand tool on one end of the fruit or vegetable with the other hand and pulling the hand tool along the length of said fruit or vegetable to peel said fruit or vegetable.

29. A method for removing the seeds, veins and skin of roasted pepper using the system of claim 18, comprising:
(a) cutting open the pepper longitudinally to expose the seeds and veins;
(b) placing the pepper on said board such that the veins and seeds are external to the board and pressing the pepper down on the board with one hand to hold the pepper against said ridges;
(c) placing the lower edge of the lower end of said hand tool on one end of the pepper with the other hand and pulling the hand tool along the length of the pepper to remove the seeds and veins; and
(d) turning the pepper over on said board and repeating step (c) to remove the skin from the pepper.
